(19) United States
(12) Patent Application Publication
(10) Pub. No.: US 2025/0226682 A1
(43) Pub. Date: Jul. 10, 2025

(54) ELECTRICITY STORAGE SYSTEM, CHARGING CONTROL METHOD, PROGRAM

(71) Applicant: Panasonic Intellectual Property Management Co., Ltd., Osaka (JP)

(72) Inventors: Masahiro NAKAJI, Kyoto (JP); Yohsuke MITANI, Osaka (JP)

(73) Assignee: Panasonic Intellectual Property Management Co., Ltd., Osaka (JP)

(21) Appl. No.: 18/847,932

(22) PCT Filed: Mar. 15, 2023
(86) PCT No.: PCT/JP2023/009991

§ 371 Date: Sep. 17, 2024

(30) Foreign Application Priority Data
Mar. 23, 2022 (JP) 2022-047625

(51) Int. Cl. H02J 7/00; H01M 10/44; H01M 10/46

(52) U.S. Cl. CPC H02J 7/00712; H01M 10/441; H01M 10/46; H02J 7/0014; H02J 7/005; H02J 7/0063

(57) ABSTRACT

An electricity storage system according to the present disclosure includes a detector, a determiner, and a charging controller. The charging controller sets, when the determiner determines, based on a result of detection by the detector, the degree of deterioration of the electrical storage unit to be a first level, a charge voltage, with which a charge circuit charges the electrical storage unit, at a first voltage. The charging controller sets, when the determiner determines the degree of deterioration to be a second level indicating more significant deterioration than the first level, the charge voltage at a second voltage higher than the first voltage. The charging controller sets, when the determiner determines the degree of deterioration to be a third level indicating more significant deterioration than the second level, the charge voltage at a third voltage higher than the second voltage.

### TECHNICAL FIELD

The present disclosure generally relates to an electricity storage system, a charging control method, and a program. More particularly, the present disclosure relates to an electricity storage system for charging an electrical storage unit, a charging control method, and a program.

### BACKGROUND ART

Patent Literature 1 discloses an onboard power supply system for supplying electricity using an electrical storage unit when a power supply unit causes a failure. The onboard power supply system includes a control unit, a deterioration determination unit, and a transmission unit. The control unit controls a charging operation by a charge circuit to allow the charge voltage at the electrical storage unit to reach a target charge voltage. The deterioration determination unit determines whether the electrical storage unit is in a predetermined deteriorated condition. If the deterioration determination unit has decided that the electrical storage unit is not in the deteriorated condition, the control unit sets the target charge voltage at a first target voltage. On the other hand, if the deterioration determination unit has decided that the electrical storage unit is in the deteriorated condition, the control unit sets the target charge voltage at a second target voltage which is greater than the first target voltage, thus making it easier to supply required backup power to a load even after the electrical storage unit has deteriorated. In addition, if the deterioration determination unit has decided that the electrical storage unit is in the deteriorated condition, then the transmission unit transmits a deterioration signal to an external device.

In the onboard power supply system, if a decision has been made that the electrical storage unit is not in the deteriorated condition, the target charge voltage is set at a first target voltage and the electrical storage unit is charged to the first target voltage. Thus, the onboard power supply system cannot extend the time it takes for the electrical storage unit to come to have the deteriorated condition.

### CITATION LIST

### Patent Literature

Patent Literature 1: JP 2018-170821 A

### SUMMARY OF INVENTION

An object of the present disclosure is to provide an electricity storage system, a charging control method, and a program, all of which contribute to reducing the deterioration of the electrical storage unit.

An electricity storage system according to an aspect of the present disclosure includes a charge circuit, a discharge circuit, a detector, a determiner, and a charging controller. The charge circuit charges an electrical storage unit with electricity supplied from a power supply. The discharge circuit outputs the electricity stored in the electrical storage unit to a load. The detector detects an electrical characteristic value that varies according to a degree of deterioration of the electrical storage unit. The determiner determines, based on a result of detection by the detector, the degree of deterioration of the electrical storage unit. The charging controller controls a charging operation of the charge circuit. The charging controller sets, when the determiner determines the degree of deterioration of the electrical storage unit to be a first level, a charge voltage, with which the charge circuit charges the electrical storage unit, at a first voltage. The charging controller sets, when the determiner determines the degree of deterioration of the electrical storage unit to be a second level indicating more significant deterioration than the first level, the charge voltage at a second voltage higher than the first voltage. The charging controller sets, when the determiner determines the degree of deterioration of the electrical storage unit to be a third level indicating more significant deterioration than the second level, the charge voltage at a third voltage higher than the second voltage.

A charging control method according to another aspect of the present disclosure is designed for use in an electricity storage system. The electricity storage system includes a charge circuit which charges an electrical storage unit with electricity supplied from a power supply; and a discharge circuit which outputs the electricity stored in the electrical storage unit to a load. The charging control method includes detection processing, determination processing, and charging control processing. The detection processing includes detecting an electrical characteristic value that varies according to a degree of deterioration of the electrical storage unit. The determination processing includes determining, based on a result of detection in the detection processing, the degree of deterioration of the electrical storage unit. The charging control processing includes controlling a charging operation of the charge circuit. The charging control processing includes setting, when the degree of deterioration of the electrical storage unit has been determined, in the determination processing, to be a first level, a charge voltage, with which the charge circuit charges the electrical storage unit, at a first voltage. The charging control processing includes setting, when the degree of deterioration of the electrical storage unit has been determined, in the determination processing, to be a second level indicating more significant deterioration than the first level, the charge voltage at a second voltage higher than the first voltage. The charging control processing includes setting, when the degree of deterioration of the electrical storage unit has been determined, in the determination processing, to be a third level indicating more significant deterioration than the second level, the charge voltage at a third voltage higher than the second voltage.

A program according to still another aspect of the present disclosure is designed to cause a computer system to perform the charging control method described above.

### BRIEF DESCRIPTION OF DRAWINGS

FIG. 1 is a schematic block circuit diagram of an electricity storage system according to an exemplary embodiment of the present disclosure;

FIG. 2 is a graph showing how the respective capacitance change rates and internal resistance change rates of an electrical storage unit included in the electricity storage system change with time:

FIG. 3 is a partially cutaway side view of a vehicle equipped with the electricity storage system:

FIG. 4 is a graph showing a relationship between the capacitance and internal resistance of the electrical storage unit and the level of deterioration in the electricity storage system:

FIG. 5 is a flowchart showing how the electricity storage system may operate:

FIG. 6 is a graph showing how a voltage at the electrical storage unit included in the electricity storage system and a current flowing through the electrical storage unit change with time:

FIG. 7 is a circuit diagram showing a main part of an electricity storage system according to a first variation; and

FIG. 8 is a schematic block circuit diagram of an electricity storage system according to a second variation.

### DESCRIPTION OF EMBODIMENTS

### Embodiment

### (1) Overview

The drawings to be referred to in the following description of embodiments are all schematic representations. Thus, the ratio of the dimensions (including thicknesses) of respective constituent elements illustrated on the drawings does not always reflect their actual dimensional ratio.

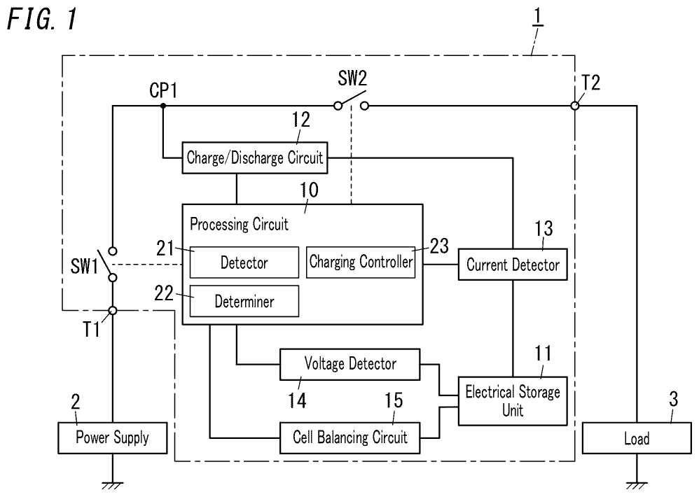

FIG. 1 is a block circuit diagram illustrating a schematic configuration for an electricity storage system 1 according to a first embodiment.

The electricity storage system 1 includes a charge circuit, a discharge circuit, a detector 21, a determiner 22, and a charging controller 23. Note that in the circuit configuration shown in FIG. 1, a charge/discharge circuit 12 serves as a charge circuit and a discharge circuit. However, this is only an example and should not be construed as limiting. The electricity storage system 1 does not have to include such a charge/discharge circuit 12 in which a charge circuit and a discharge circuit are integrated together. Alternatively, the electricity storage system 1 may include a charge circuit and a discharge circuit as two separate circuits.

The charge circuit charges an electrical storage unit 11 with electricity supplied from a power supply 2.

The discharge circuit outputs the electricity stored in the electrical storage unit 11 to a load.

The detector 21 detects an electrical characteristic value that varies according to the degree of deterioration of the electrical storage unit 11.

The determiner 22 determines the degree of deterioration of the electrical storage unit 11 based on the result of detection by the detector 21.

The charging controller 23 controls the charging operation of the charge circuit.

The charging controller 23 sets, when the determiner 22 determines the degree of deterioration of the electrical storage unit 11 to be a first level, a charge voltage, with which the charge circuit charges the electrical storage unit 11, at a first voltage. The charging controller 23 sets, when the determiner 22 determines the degree of deterioration of the electrical storage unit 11 to be a second level indicating more significant deterioration than the first level, the charge voltage at a second voltage higher than the first voltage. The charging controller 23 sets, when the determiner 22 determines the degree of deterioration of the electrical storage unit 11 to be a third level indicating more significant deterioration than the second level, the charge voltage at a third voltage higher than the second voltage. As used herein, the “charge voltage” refers to a target voltage when the charge circuit charges the electrical storage unit 11. The charge circuit continues to charge the electrical storage unit 11 until the voltage at the electrical storage unit 11 increases to a level equal to or higher than the charge voltage.

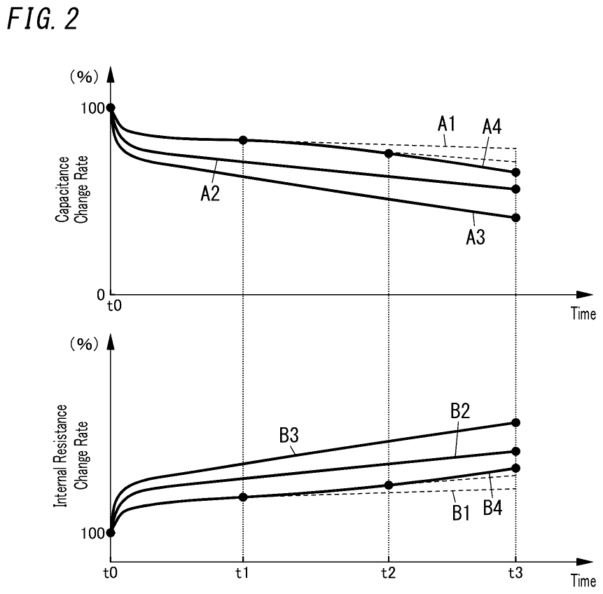

With this regard, the upper graph of FIG. 2 shows how the rate of change in the capacitance (hereinafter simply referred to as a “capacitance change rate”) of the electrical storage unit 11 changes with time from an initial stage of use of the electrical storage unit 11 (i.e., from a time t0) through a terminal stage of its performance guarantee period (i.e., through a time t3). In this case, the capacitance change rate of the electrical storage unit 11 is expressed by percentage when its capacitance at the initial stage of its use is supposed to be 100%. The lower graph of FIG. 2 shows how the rate of change in the internal resistance (hereinafter simply referred to as an “internal resistance change rate”) of the electrical storage unit 11 changes with time from the time t0 through the time t3. In this case, the internal resistance change rate of the electrical storage unit 11 is expressed by percentage when its internal resistance at the initial stage of its use is supposed to be 100%.

In the graph shown in FIG. 2, the line A1 shows data of the capacitance change rate, and the line B1 shows data of the internal resistance change rate, in a situation where a charge voltage for the electrical storage unit 11 is set at the first voltage from the time to through the time t3. The curve A2 shows data of the capacitance change rate, and the curve B2 shows data of the internal resistance change rate, in a situation where a charge voltage for the electrical storage unit 11 is set at the second voltage from the time to through the time t3. The curve A3 shows data of the capacitance change rate, and the curve B3 shows data of the internal resistance change rate, in a situation where a charge voltage for the electrical storage unit 11 is set at the third voltage from the time to through the time t3. As is clear from these data, as the electrical storage unit 11 deteriorates more significantly, the capacitance of the electrical storage unit 11 tends to decrease and the internal resistance of the electrical storage unit 11 tends to increase. Also, the higher the charge voltage of the electrical storage unit 11 is, the higher the deterioration rate of the electrical storage unit 11 is.

The charging controller 23 according to this embodiment sets the charge voltage at the first voltage when the degree of deterioration of the electrical storage unit 11 is the first level, increases the charge voltage to the second voltage when the degree of deterioration reaches the second level, and increases the charge voltage to the third voltage when the degree of deterioration reaches the third level. The curves A4, B4 shown in FIG. 2 represent the data of the capacitance change rate and the data of the internal resistance change rate, respectively, in a situation where the charge voltage is set at the first voltage when the degree of deterioration is the first level (from the time to through a time t1), the charge voltage is set at the second voltage when the degree of deterioration is the second level (from the time t1 through a time t2), and the charge voltage is set at the third voltage when the degree of deterioration is the third level (from the time t2 through the time t3).

This enables, by setting, when the degree of deterioration is the first level, the charge voltage at a lower voltage value than when the degree of deterioration is the second or third level, reducing not only the degree of decrease in capacitance at the time t3 but also the degree of increase in internal resistance at the time t3, thus achieving the advantage of reducing the deterioration of the electrical storage unit 11.

In this example, the determiner 22 determines the degree of deterioration of the electrical storage unit 11 to be any one of the three levels, namely, the first, second, and third levels. However, this is only an example and should not be construed as limiting. Alternatively, the determiner 22 may also determine the degree of deterioration of the electrical storage unit 11 at any one of four or more levels. In that case, out of the four or more levels, three levels that are arranged in either the ascending order or the descending order will be the first, second, and third levels. Thus, even if the determiner 22 determines the degree of deterioration to be any one of the four or more levels, the charging controller 23 may also increase the charge voltage step by step, every time the degree of deterioration advances from one of the three levels, selected arbitrarily from the four or more levels, to the next one.

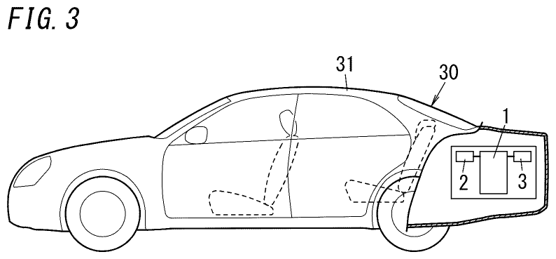

The electricity storage system 1 according to this embodiment is installed in a vehicle 30 (such as an automobile) (refer to FIG. 3). That is to say, the vehicle 30 includes the electricity storage system 1 and a vehicle body 31. The vehicle body 31 is equipped with the electricity storage system 1, the power supply 2, and the load 3.

The electricity storage system 1 charges, when an ignition switch of the vehicle 30 is turned ON, the electrical storage unit 11 with the electricity supplied from the power supply 2 of the vehicle 30.

The electricity storage system 1 supplies, when the power supply 2 of the vehicle 30 (such as a battery of the vehicle 30) causes a failure (hereinafter referred to as a “failure state”), for example, electricity from the electrical storage unit 11 to the load 3. Optionally, even if the power supply 2 causes no failure (hereinafter referred to as a “non-failure state”), the electricity storage system 1 may also supply electricity from the electrical storage unit 11 to the load 3 in addition to the electricity supplied from the power supply 2. The load 3 is a load installed in the vehicle 30 and includes, for example, an electronic control unit (ECU) associated with an advanced driver-assistance system (ADAS). The load 3 may include an ECU and other control units for controlling the operation of an electric braking system installed in the vehicle 30.

The electricity storage system 1 according to this embodiment allows, even if the power supply 2 causes a failure or if the power supply 2 has come to have a low battery level, the load 3 to continue to operate with the electricity supplied from the electrical storage unit 11. As used herein, the “failure state” in which the power supply 2 causes a failure refers to a state where supply of electricity from the power supply 2 to the load 3 is cut off due to, for example, failure, deterioration, or disconnection of the power supply 2. The “non-failure state” in which the power supply 2 causes no failure herein refers to a state where electricity may be supplied from the power supply 2 to the load 3.

Note that FIG. 3 is a schematic representation of the vehicle 30 in which the electricity storage system 1 is installed. In the vehicle body 31, the electricity storage system 1, the power supply 2, and the load 3 do not have to be provided at the positions shown in FIG. 3 but may be changed as appropriate.

Also, in the following description, an example in which the electricity storage system 1 is installed in a vehicle 30 such as an automobile will be described as an example. However, the vehicle 30 does not have to be an automobile but may also be, for example, a motorcycle, an electric bicycle, or a railway train.

### (2) Details

Next, the electricity storage system 1 according to this embodiment will be described in detail with reference to FIGS. 1-6.

### (2.1) Configuration

The electricity storage system 1 includes the charge/discharge circuit 12 serving as both a charge circuit and a discharge circuit, the detector 21, the determiner 22, and the charging controller 23 as described above. The electricity storage system 1 further includes a first terminal T1, a second terminal T2, a first switch SW1, a second switch SW2, a processing circuit 10 having the functions of the detector 21, the determiner 22, and the charging controller 23, the electrical storage unit 11, a current detector 13, a voltage detector 14, and a cell balancing circuit 15.

A power supply 2 such as the battery of the vehicle 30 is connected to the first terminal T1.

The load 3 is connected to the second terminal T2. The load 3 is installed in the vehicle 30 and may include, for example, a control system such as an ADAS-related ECU.

The electrical storage unit 11 may be, for example, an electrical double layer capacitor (EDLC) which may be quickly charged and discharged. The electrical storage unit 11 may be made up of two or more electrical storage devices (such as EDLCs) which are electrically connected to each other in parallel or in series. Alternatively, the electrical storage unit 11 may also be formed by connecting, in parallel, a plurality of series circuits, in each of which two or more electrical storage devices are connected in series. That is to say, the electrical storage unit 11 may be implemented as a parallel or series circuit of two or more electrical storage devices (hereinafter referred to as “cells”) or a combination thereof.

A first end of the first switch SW1 is connected to the first terminal T1. The first switch SW1 may be a semiconductor switch such as a metal-oxide semiconductor field effect transistor (MOSFET) and is controlled to ON or OFF state by the processing circuit 10.

The second switch SW2 is connected between a second end of the first switch SW1 and the second terminal T2. The second switch SW2 may be a semiconductor switch such as a MOSFET and is controlled to ON or OFF state by the processing circuit 10.

The charge/discharge circuit 12 is connected between a connection node CP1 of the first switch SW1 and the second switch SW2 and the electrical storage unit 11. The connection node CP1 is a node on a path between the first switch SW1 and the second switch SW2. The charge/discharge circuit 12 may be, for example, a bidirectional DC-DC converter circuit and operates in either a charge mode or a discharge mode. When operating in the charge mode, the charge/discharge circuit 12 is supplied with electricity from the power supply 2 to charge the electrical storage unit 11. When operating in the discharge mode, the charge/discharge circuit 12 transforms the output voltage of the electrical storage unit 11 and outputs the voltage thus transformed to the connection node CP1.

The current detector 13 detects, using a current sensor such as a Hall element, the current value of a current flowing between the charge/discharge circuit 12 and the electrical storage unit 11 and outputs the current value thus detected to the processing circuit 10.

The voltage detector 14 detects the voltage value of the charge voltage of the electrical storage unit 11 and outputs the voltage value thus detected to the processing circuit 10.

The cell balancing circuit 15 regulates, under the control of the charging controller 23, the charge voltages of the respective cells to equalize the respective voltages of the plurality of cells included in the electrical storage unit 11 with each other. That is to say, in this embodiment, the electrical storage unit 11 includes a plurality of cells which are connected together in series and the charging controller 23 controls charging of the plurality of cells by the charge/discharge circuit 12 to equalize the charge voltages of the plurality of cells with each other.

The processing circuit 10 includes, for example, a computer system including a processor and a memory. The computer system performs the functions of the processing circuit 10 by making the processor execute a program stored in the memory. In this embodiment, the program executed by the processor is stored in advance in the memory of the computer system. Alternatively, the program may also be distributed after having been stored in a non-transitory storage medium such as a memory card or downloaded via a telecommunications line such as the Internet.

The processing circuit 10 has the functions of the detector 21, the determiner 22, and the charging controller 23 described above.

In addition, the processing circuit 10 also controls the supply of electricity to the load 3 by controlling the ON/OFF states of the first switch SW1 and the second switch SW2. The processing circuit 10 monitors the voltage being input to the first terminal T1 and compares the voltage input to the first terminal T1 with a predetermined reference voltage, thereby determining whether the power supply 2 is in a failure state or a non-failure state. If the power supply 2 is in the non-failure state, the processing circuit 10 turns the first switch SW1 and the second switch SW2 ON. In that case, electricity is supplied from the power supply 2 to the load 3 via the first switch SW1 and the second switch SW2 and the charge/discharge circuit 12 charges the electrical storage unit 11 with the electricity supplied from the power supply 2. On the other hand, if the power supply 2 is in the failure state, the processing circuit 10 turns the first switch SW1 OFF and turns the second switch SW2 ON. In that case, the charge/discharge circuit 12 supplies the electricity stored in the electrical storage unit 11 to the load 3, thereby allowing the load 3 to operate with the electricity supplied from the electrical storage unit 11.

The detector 21 detects an electrical characteristic value that varies according to the degree of deterioration of the electrical storage unit 11. As described above, as the electrical storage unit 11 deteriorates more significantly, the capacitance and internal resistance of the electrical storage unit 11 change. Thus, the detector 21 detects the capacitance and internal resistance of the electrical storage unit 11 as electrical characteristic values. In other words, the electrical characteristic values detected by the detector 21 include the capacitance of the electrical storage unit 11 and the internal resistance of the electrical storage unit 11. However, the electrical characteristic values are not limited to the capacitance and internal resistance of the electrical storage unit 11 but may also be values obtained based on the capacitance and internal resistance of the electrical storage unit 11 or values obtained based on a leakage current. The electrical characteristic values may also be a capacitance change rate and an internal resistance change rate, for example, and may be changed as appropriate.

In this embodiment, the detector 21 detects the capacitance and internal resistance of the electrical storage unit 11 based on the current value detected by the current detector 13 and the voltage value detected by the voltage detector 14 while the electrical storage unit 11 is being charged. Specifically, as the charge voltage increases by a predetermined voltage while the electrical storage unit 11 is being charged, the detector 21 may calculate, for example, an integrated value of current values of the charge current detected by the current detector 13, divide the integrated value of the charge current by an increase in the charge voltage, and thereby calculate the capacitance of the electrical storage unit 11 based on the quotient thus calculated. In addition, the detector 21 may, for example, decrease the charge current to zero while the electrical storage unit 11 is being charged, divide the variation in the charge voltage before and after the charge current is decreased to zero by the current value before the charge current is decreased to zero, and thereby calculate the internal resistance of the electrical storage unit 11 based on the quotient thus calculated.

The determiner 22 determines the degree of deterioration of the electrical storage unit 11 based on the electrical characteristic values (e.g., the capacitance and internal resistance of the electrical storage unit 11) detected by the detector 21 while the electrical storage unit 11 is being charged. Specifically, the determiner 22 determines the current degree of deterioration of the electrical storage unit 11 based on not only data representing the correlation between the capacitance and internal resistance of the electrical storage unit 11 and the degree of deterioration but also the capacitance and internal resistance of the electrical storage unit 11 detected by the detector 21 while the electrical storage unit 11 is being charged by the charge/discharge circuit 12. When the degree of deterioration of the electrical storage unit 11 changes, the determiner 22 has the current degree of deterioration stored in a nonvolatile memory included in the processing circuit 10.

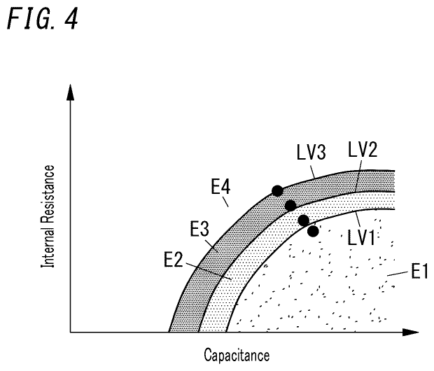

With this regard, FIG. 4 is a graph showing an exemplary correlation between the capacitance and internal resistance of the electrical storage unit 11 and the degree of deterioration. Supposing the capacitance of the electrical storage unit 11 remains the same, as the internal resistance increases, the deterioration progresses more significantly. Also, supposing the internal resistance of the electrical storage unit 11 remains the same, as the capacitance decreases, the deterioration progresses more significantly. In FIG. 4, a curve LV1 indicates a boundary between the first and second levels of deterioration, a curve LV2 indicates a boundary between the second and third levels of deterioration, and a curve LV3 indicates a boundary between the third level of deterioration and a terminal condition after the performance guarantee period has expired.

When finding a data point, set by plotting out, in the graph shown in FIG. 4, the capacitance and internal resistance of the electrical storage unit 11 that have been detected by the detector 21, located in a region E1 on the lower right of the curve LV1, the determiner 22 determines the degree of deterioration of the electrical storage unit 11 to be the first level. On the other hand, when finding a data point, set by plotting out, in the graph shown in FIG. 4, the capacitance and internal resistance of the electrical storage unit 11 that have been detected by the detector 21, located in a region E2 between the curve LV1 and the curve LV2, the determiner 22 determines the degree of deterioration of the electrical storage unit 11 to be the second level. Furthermore, when finding a data point, set by plotting out, in the graph shown in FIG. 4, the capacitance and internal resistance of the electrical storage unit 11 that have been detected by the detector 21, located in a region E3 between the curve LV2 and the curve LV3, the determiner 22 determines the degree of deterioration of the electrical storage unit 11 to be the third level. Furthermore, when finding a data point, set by plotting out, in the graph shown in FIG. 4, the capacitance and internal resistance of the electrical storage unit 11 that have been detected by the detector 21, located in a region E4 on the upper left of the curve LV3, the determiner 22 determines the degree of deterioration of the electrical storage unit 11 to be a terminal condition. Note that the graph shown in FIG. 4 is provided to illustrate how the determiner 22 determines the degree of deterioration and the determiner 22 does not have to retain the data of the graph shown in FIG. 4. Rather, the determiner 22 may determine the current degree of deterioration of the electrical storage unit 11 based on the capacitance and internal resistance of the electrical storage unit 11 that have been detected by the detector 21 and data about the correlation between the capacitance and internal resistance of the electrical storage unit 11 and the degree of deterioration.

### (2.2) Operation

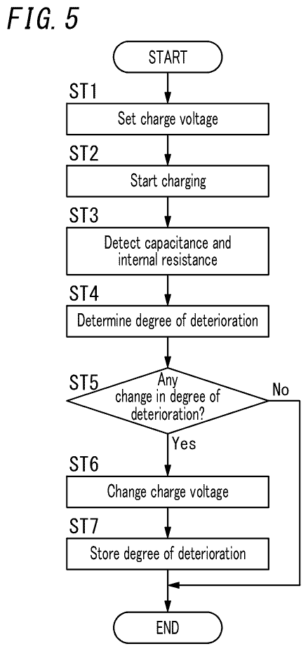

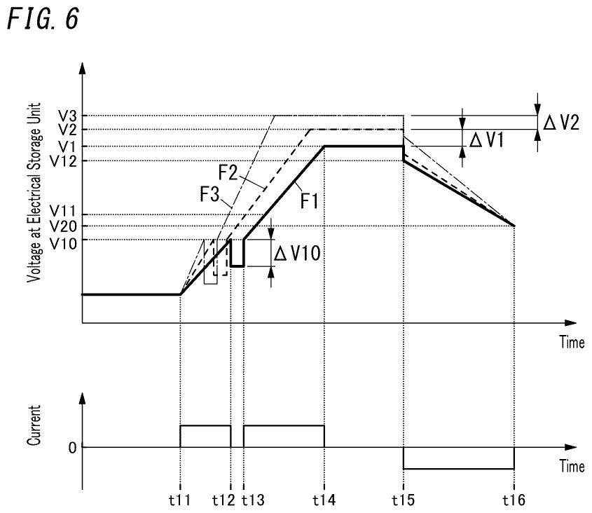

Next, it will be described with reference to FIGS. 5 and 6 how the electricity storage system 1 according to this embodiment operates. Note that the flowchart shown in FIG. 5 shows only an example of the charging control method according to this embodiment and should not be construed as limiting. Optionally, the processing steps shown in FIG. 5 may be performed in a different order from the illustrated one, some of the processing steps shown in FIG. 5 may be omitted as appropriate, and/or an additional processing step may be performed as needed. FIG. 6 is a graph showing how a voltage at the electrical storage unit 11 and a current flowing through the electrical storage unit 11 change with time. In FIG. 6, the polygon F1 indicates data collected when the electrical storage unit 11 is charged to a first voltage V1, the polygon F2 indicates data collected when the electrical storage unit 11 is charged to a second voltage V2, and the polygon F3 indicates data collected when the electrical storage unit 11 is charged to a third voltage V3.

For example, when the ignition switch of the vehicle 30 turns from OFF to ON to make the voltage applied from the power supply 2 to the first terminal T1 greater than a predetermined reference voltage at a time t11 shown in FIG. 6, the processing circuit 10 turns the first switch SW1 and the second switch SW2 ON based on the voltage detected at the first terminal T1. In addition, the charging controller 23 reads out, from a nonvolatile memory, data about the degree of deterioration of the electrical storage unit 11 that was determined during the previous charging session and sets the charge voltage based on the degree of deterioration of the electrical storage unit 11 (in Step ST1). In this case, in the initial stage of use of the electricity storage system 1, the degree of deterioration is the first level, and therefore, the charging controller 23 sets the charge voltage of the electrical storage unit 11 at the first voltage V1.

After having set the charge voltage of the electrical storage unit 11, the charging controller 23 causes the charge/discharge circuit 12 to operate in the charge mode to make the charge/discharge circuit 12 charge the electrical storage unit 11 (in Step ST2). Note that the charge/discharge circuit 12 charges the electrical storage unit 11 by causing a current with a predetermined current value to flow through the electrical storage unit 11.

Then, while the charge/discharge circuit 12 is charging the electrical storage unit 11, the detector 21 performs detection processing including detecting the capacitance and internal resistance of the electrical storage unit 11 (in Step ST3).

When the voltage at the electrical storage unit 11 increases to reach a voltage V10, for example (at a time t12 shown in FIG. 6), the detector 21 causes the charge/discharge circuit 12 to temporarily stop charging the electrical storage unit 11 to detect a voltage decrease ΔV10 at that time. In addition, the detector 21 has also acquired, from the current detector 13, the value of the current I1 that had been supplied to the electrical storage unit 11 before the charge/discharge circuit 12 stopped charging (at the time t12) and divides the voltage decrease ΔV10 by the current value I1 at the time t12 (i.e., calculates ΔV10/11), thereby calculating the internal resistance of the electrical storage unit 11.

After the detector 21 has calculated the internal resistance (at a time t13 shown in FIG. 6), the charging controller 23 allows the charge/discharge circuit 12 to resume charging the electrical storage unit 11.

Next, while the voltage at the electrical storage unit 11 is increasing from the voltage V11 to the voltage V12, the detector 21 calculates an integrated value of the charge current supplied to the electrical storage unit 11. Supposing the time it takes for the voltage at the electrical storage unit 11 to increase from the voltage V11 to the voltage V12 is Δt1, the integrated value of the charge current in the meantime will be I1×Δt1. Then, the detector 21 divides the integrated value (I1×Δt1) of the charge current by the difference (V12−V11) between the voltages V12 and V11 (i.e., calculates (I1×Δt1)/(V12−V11)), and thereby calculates the capacitance of the electrical storage unit 11 based on (I1×Δt1)/(V12−V11).

After the detector 21 has calculated the capacitance and internal resistance of the electrical storage unit 11, the determiner 22 determines the degree of deterioration of the electrical storage unit 11 depending on in which of the regions E1-E4 the data point, set by plotting out the current capacitance and internal resistance of the electrical storage unit 11 in the graph shown in FIG. 4, is located (in Step ST4).

In this case, unless the degree of deterioration of the electrical storage unit 11 has changed (if the answer is NO in Step ST5), the processing circuit 10 ends the deterioration determination processing.

On the other hand, if the degree of deterioration of the electrical storage unit 11 has changed (if the answer is YES in Step ST5), then the charging controller 23 changes the charge voltage of the electrical storage unit 11 according to the level of deterioration (in Step ST6) and has the current degree of deterioration of the electrical storage unit 11 stored in a nonvolatile memory (in Step ST7).

Thereafter, when the voltage at the electrical storage unit 11 increases to reach a charge voltage corresponding to the degree of deterioration (at a time t14 shown in FIG. 6), the charge/discharge circuit 12 maintains the voltage at the electrical storage unit 11 at the charge voltage by subjecting the electrical storage unit 11 to trickle charging, for example.

Also, when a failure is caused to the power supply 2 at a time t15, the processing circuit 10 causes the charge/discharge circuit 12 to operate in the discharge mode by turning the first switch SW1 OFF and turning the second switch SW2 ON. That is to say, when the power supply 2 causes a failure, the discharge circuit (charge/discharge circuit 12) discharges electricity from the electrical storage unit 11 and supplies the electricity to the load 3. This allows, even when the power supply 2 causes a failure, the load 3 to operate by supplying electricity from the electrical storage unit 11 to the load 3. In addition, even at a time t16 when the predetermined operation guarantee period has passed since the time t15, the voltage at the electrical storage unit 11 is still equal to or higher than the operation guarantee voltage V20 of the load 3, thus allowing the load 3 to operate with good stability.

Note that when the degree of deterioration of the electrical storage unit 11 has reached the second level, the charging controller 23 sets the charge voltage of the electrical storage unit 11 at a second voltage V2 higher than the first voltage V1, thereby charging the electrical storage unit 11 to the second voltage V2. When the degree of deterioration of the electrical storage unit 11 has reached the third level, the charging controller 23 sets the charge voltage of the electrical storage unit 11 at a third voltage V3 higher than the second voltage V2, thereby charging the electrical storage unit 11 to the third voltage V3. As the electrical storage unit 11 deteriorates more significantly, the electrical storage unit 11 comes to have decreased capacitance and increased internal resistance, thus causing an increase in the voltage drop rate of the electrical storage unit 11 at the time of discharging. According to this embodiment, as the level of deterioration progresses, the charge voltage is set at an increasing value. This enables, even if the degree of deterioration has progressed to the second level and then to the third level, keeping the voltage at the electrical storage unit 11 equal to or higher than the operation guarantee voltage V20 of the load 3 since the beginning of discharging until the operation guarantee period expires, thus allowing the load 3 to operate with good stability.

In addition, according to this embodiment, the charging controller 23 sets the first to third voltages V1-V3 such that a second increment ΔV2 representing the difference (V3−V2) of the third voltage V3 from the second voltage V2 is less than a first increment ΔV1 representing the difference (V2−V1) of the second voltage V2 from the first voltage V1. This allows the difference of the first voltage V1 from the second voltage V2 to be set at a lower voltage value than the difference of the second voltage V2 from the third voltage V3, thereby reducing not only the degree of decrease in the capacitance of the electrical storage unit 11 but also the degree of increase in the internal resistance thereof as well.

### (3) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. Also, the functions of the electricity storage system 1 may also be implemented as, for example, a charging control method designed for use in the electricity storage system 1, a computer program, or a non-transitory storage medium on which the program is stored. A charging control method according to an aspect is designed for use in an electricity storage system 1. The electricity storage system 1 includes a charge circuit (charge/discharge circuit 12) which charges an electrical storage unit 11 with electricity supplied from a power supply 2; and a discharge circuit (charge/discharge circuit 12) which outputs the electricity stored in the electrical storage unit 11 to a load 3. The charging control method includes detection processing, determination processing, and charging control processing. The detection processing includes detecting an electrical characteristic value that varies according to the degree of deterioration of the electrical storage unit 11. The determination processing includes determining, based on a result of detection in the detection processing, the degree of deterioration of the electrical storage unit 11. The charging control processing includes controlling a charging operation of the charge circuit (charge circuit 12). The charging control processing includes setting, when the degree of deterioration of the electrical storage unit 11 has been determined, in the determination processing, to be a first level, a charge voltage, with which the charge circuit (charge/discharge circuit 12) charges the electrical storage unit 11, at a first voltage V1. The charging control processing includes setting, when the degree of deterioration of the electrical storage unit 11 has been determined, in the determination processing, to be a second level indicating more significant deterioration than the first level, the charge voltage at a second voltage V2 higher than the first voltage V1. The charging control processing includes setting, when the degree of deterioration of the electrical storage unit 11 has been determined, in the determination processing, to be a third level indicating more significant deterioration than the second level, the charge voltage at a third voltage V3 higher than the second voltage V2. A (computer) program according to another aspect is designed to cause a computer system to perform the charging control method described above.

Next, variations of the exemplary embodiment will be enumerated one after another. Note that the variations to be described below may be adopted in combination as appropriate.

The electricity storage system 1 according to the present disclosure or the agent that performs the charging control method according to the present disclosure includes a computer system. The computer system may include a processor and a memory as principal hardware components thereof. The computer system performs the functions of the electricity storage system 1 according to the present disclosure or serves as the agent that performs the charging control method according to the present disclosure by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Also, in the embodiment described above, the plurality of functions of the electricity storage system 1 are aggregated in a single housing. However, this is not an essential configuration for the electricity storage system 1. Alternatively, those constituent elements of the electricity storage system 1 may be distributed in multiple different housings. Still alternatively, at least some functions of the electricity storage system 1 (e.g., some functions of the electricity storage system 1 such as the function of the determiner 22) may be implemented as a cloud computing system as well.

Note that the processing circuit 10 does not have to be implemented as a computer system but may also be implemented as an analog circuit.

In the embodiment described above, the plurality of functions of the electricity storage system 1 are aggregated in a single housing. However, this is not an essential configuration for the electricity storage system 1. Alternatively, those constituent elements of the electricity storage system 1 may be distributed in multiple different housings. Still alternatively, at least some functions of the electricity storage system 1 (e.g., some functions of either the determiner 22 or the charging controller 23) may be implemented as a cloud computing system as well. Also, if the electricity storage system 1 is installed in the vehicle 30, some functions of either the determiner 22 or the charging controller 23 may be performed by the ECU of the vehicle 30.

Furthermore, in the foregoing description of embodiments, if one of two values being compared with each other (such as voltage values) is “greater than” the other, the phrase “greater than” may also be a synonym of the phrase “equal to or greater than” that covers both a situation where these two values are equal to each other and a situation where one of the two values is greater than the other. That is to say, it is arbitrarily changeable, depending on selection of a reference value or any preset value, whether or not the phrase “greater than” covers the situation where the two values are equal to each other. Therefore, from a technical point of view, there is no difference between the phrase “greater than” and the phrase “equal to or greater than.” Similarly, the phrase “equal to or less than” may be a synonym of the phrase “less than” as well. Therefore, from a technical point of view, there is no difference between the phrase “equal to or less than” and the phrase “less than.”

### (3.1) First Variation

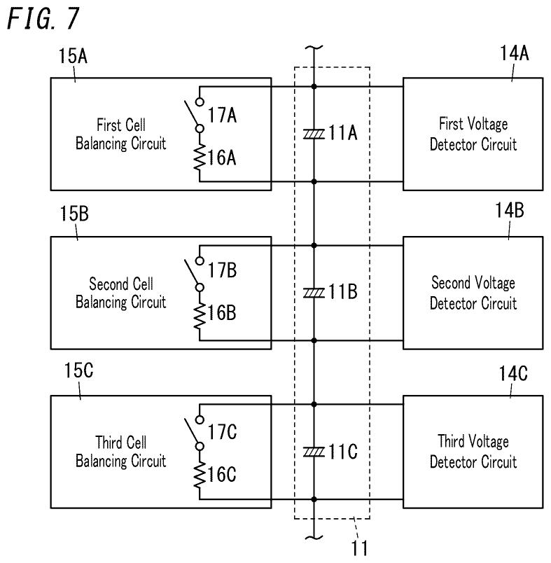

Next, an electricity storage system 1 according to a first variation will be described with reference to FIG. 7. All constituent elements of the electricity storage system 1 according to the first variation, but the electrical storage unit 11, the voltage detector 14, and the cell balancing circuit 15 thereof, are the same as their counterparts of the electricity storage system 1 according to the first embodiment described above. Thus, each of those constituent elements of this first variation, having the same function as its counterpart of the first embodiment described above, will be designated by the same reference numeral as that counterpart's, and description thereof will be omitted herein.

In the electricity storage system 1 according to the first variation, the electrical storage unit 11 includes a plurality of (e.g., three) cells 11A-11C which are connected together in series. The determiner 22 determines, based on cell decision values representing respective degrees of deterioration of the plurality of cells 11A-11C, the degree of deterioration of the electrical storage unit 11 as a whole. As used herein, the cell decision values are electrical characteristic values obtained for the respective cells 11A-11C and are electrical characteristic values that vary according to the degrees of deterioration of the respective cells. The cell decision values may include capacitance and internal resistance values or leakage currents obtained with respect to the plurality of cells 11A-11C. Note that the cell decision values do not have to be the capacitance and internal resistance values obtained with respect to the plurality of cells 11A-11C but may also be capacitance change rates and internal resistance change rates of the respective cells and may be changed as appropriate.

Specifically, the voltage detector 14 includes first to third voltage detector circuits 14A-14C for detecting the cell voltages of the three cells 11A-11C, respectively.

The detector 21 detects, as the cell decision values of the respective cells, the capacitance and internal resistance values of the plurality of cells 11A-11C using the cell voltages detected by the first to third voltage detector circuits 14A-14C and the current value detected by the current detector 13.

Then, the determiner 22 calculates, based on the cell decision values (capacitance and internal resistance values) of the respective cells 11A-11C that have been detected by the detector 21, a combined capacitance of the plurality of cells 11A-11C and a combined internal resistance value thereof, thereby determining the degree of deterioration of the electrical storage unit 11 based on the combined capacitance and combined internal resistance. This allows the electricity storage system 1 according to this embodiment to determine the degree of deterioration of the electrical storage unit 11 more accurately. Note that the determiner 22 determines the degree of deterioration of the electrical storage unit 11 based on the combined capacitance and combined internal resistance value of the plurality of cells 11A-11C in the same way as in the exemplary embodiment described above, and therefore, description thereof will be omitted herein.

In the circuit shown in FIG. 7, the electrical storage unit 11 includes the three cells 11A-11C. However, the electrical storage unit 11 only needs to include a plurality of cells and the number of the cells provided may also be two or four or more. In that case, a plurality of voltage detector circuits for detecting the voltages of the plurality of cells on an independent basis may be provided and the detector 21 may detect the capacitance and internal resistance values of the respective cells based on the plurality of cell voltages detected by the plurality of voltage detector circuits and the current value detected by the current detector 13.

Alternatively, in the electricity storage system 1 according to the first variation, the determiner 22 may also determine the degrees of deterioration of the respective cells based on the cell decision values of the plurality of cells 11A-11C. Then, the charging controller 23 may control the charge voltages of the respective cells based on the degrees of deterioration of the respective cells that have been determined by the determiner 22. For example, the charging controller 23 may set, based on the respective cell decision values of the plurality of cells 11A-11C, a first cell voltage that is the charge voltage of a first cell belonging to the plurality of cells 11A-11C at a lower voltage than a second cell voltage that is the charge voltage of a second cell. The second cell is a cell that has deteriorated less significantly (in other words, a cell that has deteriorated more slowly) than the first cell among the plurality of cells 11A-11C.

In the electricity storage system 1 according to the first variation, a cell balancing circuit is connected to each of the plurality of cells 11A-11C. That is to say, first to third cell balancing circuits 15A-15C are connected to the three cells 11A-11C, respectively.

The first cell balancing circuit 15A includes a series circuit of a switch 17A and a resistor 16A which is connected across the cell 11A.

The second cell balancing circuit 15B includes a series circuit of a switch 17B and a resistor 16B which is connected across the cell 11B.

The third cell balancing circuit 15C includes a series circuit of a switch 17C and a resistor 16C which is connected across the cell 11C.

These switches 17A-17C have their ON/OFF states controlled by the charging controller 23.

As described above, the detector 21 obtains, as the cell decision values representing the respective degrees of deterioration of the cells 11A-11C, the capacitance and internal resistance values of the respective cells 11A-11C, and therefore, the determiner 22 determines the degrees of deterioration of the respective cells based on the capacitance and internal resistance values of the respective cells.

The charging controller 23 controls the charge voltages of the respective cells 11A-11C based on the respective degrees of deterioration of the cells 11A-11C that have been determined by the determiner 22. Specifically, the charging controller 23 may set the first cell voltage that is the charge voltage of the first cell belonging to the plurality of cells 11A-11C at a lower voltage than the second cell voltage that is the charge voltage of the second cell.

When starting performing the charging operation, the charging controller 23 allows a charge current to flow through the cells 11A-11C with all of the switches 17A-17C turned OFF, thereby charging the respective cells 11A-11C. For example, if the cell 11A has deteriorated more significantly than the cell 11B, 11C, then the charging controller 23 may set the first cell voltage of the cell 11A as the first cell at a lower voltage than the second cell voltage of the cell 11B, 11C that is the second cell. Then, when the charge voltage of the first cell (i.e., the cell 11A) that has been detected by the first voltage detector circuit 14A reaches the first cell voltage, the charging controller 23 turns the switch 17A from OFF to ON to cause a charge current to flow through a series circuit of the resistor 16A and the cell 11B, 11C. At this time, the charging controller 23 stops charging the cell 11A as the first cell and continues charging the cell 11B, 11C as the second cell. This allows the electricity storage system 1 according to the first variation to set the first cell voltage of the first cell that has deteriorated more significantly than the second cell at a voltage lower than the second cell voltage, thus enabling reducing further deterioration of the first cell.

Optionally, in the electricity storage system 1 according to the first variation, the charging controller 23 may charge the plurality of cells 11A-11C to equalize the respective charge voltages of the plurality of cells 11A-11C with each other, thus allowing the plurality of cells 11A-11C to be charged with balance struck well between the plurality of cells 11A-11C.

### (3.2) Second Variation

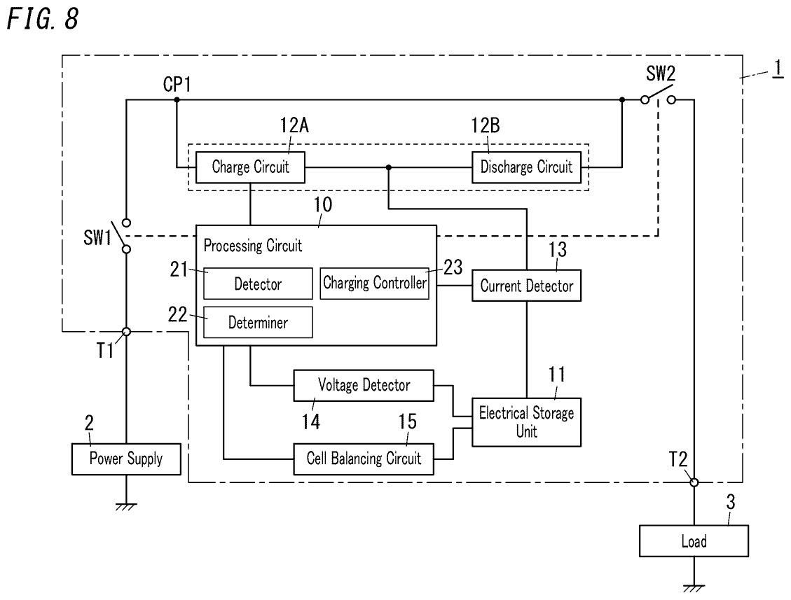

Next, an electricity storage system 1 according to a second variation will be described with reference to FIG. 8.

The electricity storage system 1 according to the second variation includes a charge circuit 12A and a discharge circuit 12B, which is a difference from the electricity storage system 1 according to the first embodiment. All constituent elements of the electricity storage system 1 according to the second variation, but the charge circuit 12A and the discharge circuit 12B, are the same as their counterparts of the electricity storage system 1 according to the first embodiment described above. Thus, any constituent element of this second variation, having the same function as a counterpart of the first embodiment described above, will be designated by the same reference numeral as that counterpart's, and description thereof will be omitted herein.

The charge circuit 12A is connected between the connection node CP1 of the first switch SW1 and the second switch SW2 and the electrical storage unit 11. When the power supply 2 causes no failure, the charge circuit 12A is supplied with electricity by the power supply 2 to charge the electrical storage unit 11.

The discharge circuit 12B is connected between the electrical storage unit 11 and the second switch SW2. The discharge circuit 12B outputs the electricity stored in the electrical storage unit 11 to the load. When the power supply 2 causes a failure, the discharge circuit 12B transforms the output voltage of the electrical storage unit 11 and outputs the voltage thus transformed to the second terminal T2. Optionally, when the power supply 2 causes no failure, the discharge circuit 12B may also transform the output voltage of the electrical storage unit 11 and output the voltage thus transformed to the second terminal T2. This allows electricity to be supplied from both the power supply 2 and the electrical storage unit 11 to the load 3.

### (3.3) Other Variations

In the exemplary embodiment described above, the electrical storage unit 11 does not have to be an electrical double layer capacitor but may also be a secondary battery such as a lithium-ion capacitor (LIC) or a lithium-ion battery (LIB). In the lithium-ion capacitor, the cathode thereof may be made of the same material (such as activated carbon) as an EDLC and the anode thereof may be made of the same material (e.g., a carbon material such as graphite) as an LIB.

The electrical storage unit 11 may also be, for example, an electrochemical device having a configuration to be described below. As used herein, the “electrochemical device” includes a cathode member, an anode member, and a nonaqueous electrolyte solution. The cathode member includes a cathode current collector and a cathode material layer supported by the cathode current collector and containing a cathode active material. The cathode material layer contains a conductive polymer serving as a cathode active material for doping and de-doping an anion (dopant). The anode member includes an anode material layer containing an anode active material. The anode active material may be, for example, a material that advances an oxidation-reduction reaction involving occlusion and release of a lithium ion. Specifically, examples of the anode active material include carbon materials, metal compounds, alloys, and ceramics. The nonaqueous electrolyte solution may have, for example, lithium-ion conductivity. A nonaqueous electrolyte solution of this type includes a lithium salt and a nonaqueous solution that dissolves the lithium salt. An electrochemical device having such a configuration has a higher energy density than an electrical double layer capacitor, for example.

In the exemplary embodiment described above, the processing circuit 10 does not have to be implemented as a computer system but may also be implemented as an analog circuit.

Furthermore, the electricity storage system 1 does not have to include the detector 21 but the detector 21 may be omitted as appropriate. As long as the electrical characteristic values of the electrical storage unit 11 may be acquired from an external device, the determiner 22 may determine the degree of deterioration of the electrical storage unit 11 based on the electrical characteristic values acquired from the external device.

In the exemplary embodiment described above, the electricity storage system 1 supplies electricity from the electrical storage unit 11 to the load 3 when the power supply 2 implemented as the battery of the vehicle 30 causes a failure. Alternatively, electricity may also be supplied from both the power supply 2 and the electrical storage unit 11 to the load 3 even when the power supply 2 causes no failure.

### (Recapitulation)

As can be seen from the foregoing description, an electricity storage system (1) according to a first aspect includes a charge circuit (12, 12A), a discharge circuit (12, 12B), a detector (21), a determiner (22), and a charging controller (23). The charge circuit (12, 12A) charges an electrical storage unit (11) with electricity supplied from a power supply (2). The discharge circuit (12, 12B) outputs the electricity stored in the electrical storage unit (11) to a load (3). The detector (21) detects an electrical characteristic value that varies according to a degree of deterioration of the electrical storage unit (11). The determiner (22) determines, based on a result of detection by the detector (21), the degree of deterioration of the electrical storage unit (11). The charging controller (23) controls a charging operation of the charge circuit (12, 12A). The charging controller (23) sets, when the determiner (22) determines the degree of deterioration of the electrical storage unit (11) to be a first level, a charge voltage, with which the charge circuit (12, 12A) charges the electrical storage unit (11), at a first voltage (V1). The charging controller (23) sets, when the determiner (22) determines the degree of deterioration of the electrical storage unit (11) to be a second level indicating more significant deterioration than the first level, the charge voltage at a second voltage (V2) higher than the first voltage (V1). The charging controller (23) sets, when the determiner (22) determines the degree of deterioration of the electrical storage unit (11) to be a third level indicating more significant deterioration than the second level, the charge voltage at a third voltage (V3) higher than the second voltage (V2).

This aspect enables, by setting, when the degree of deterioration is the first level, the charge voltage at a lower voltage value than when the degree of deterioration is the second or third level, reducing not only the degree of decrease in capacitance but also the degree of increase in internal resistance, thus achieving the advantage of reducing the deterioration of the electrical storage unit (11).

In an electricity storage system (1) according to a second aspect, which may be implemented in conjunction with the first aspect, the electrical characteristic value detected by the detector (21) includes a capacitance of the electrical storage unit (11) and an internal resistance of the electrical storage unit (11).

This aspect enables determining the degree of deterioration of the electrical storage unit (11) based on the capacitance of the electrical storage unit (11) and the internal resistance of the electrical storage unit (11).

In an electricity storage system (1) according to a third aspect, which may be implemented in conjunction with the first or second aspect, a second increment (ΔV2) representing a difference of the third voltage (V3) from the second voltage (V2) is less than a first increment (ΔV1) representing a difference of the second voltage (V2) from the first voltage (V1).

This aspect enables, by setting the difference of the first voltage (V1) from the second voltage (V2) at a lower voltage value than the difference of the second voltage (V2) from the third voltage (V3), reducing not only the degree of decrease in the capacitance of the electrical storage unit (11) but also the degree of increase in the internal resistance thereof.

In an electricity storage system (1) according to a fourth aspect, which may be implemented in conjunction with any one of the first to third aspects, the electrical storage unit (11) includes a plurality of cells (11A-11C) connected together in series. The determiner (22) determines, based on cell decision values indicating respective degrees of deterioration of the plurality of cells (11A-11C), the degree of deterioration of the electrical storage unit (11) as a whole.

This aspect enables determining the degree of deterioration of the electrical storage unit (11) more accurately by determining the degree of deterioration of the electrical storage unit (11) as a whole based on the respective cell decision values of the plurality of cells (11A-11C).

In an electricity storage system (1) according to a fifth aspect, which may be implemented in conjunction with the fourth aspect, the charging controller (23) sets, according to the respective cell decision values of the plurality of cells (11A-11C), a first cell voltage at a value lower than a second cell voltage. The first cell voltage is a charge voltage for a first cell belonging to the plurality of cells (11A-11C). The second cell voltage is a charge voltage for a second cell belonging to the plurality of cells (11A-11C). The second cell deteriorates more slowly than the first cell.

According to this aspect, the first cell voltage of the first cell that has deteriorated more seriously than the second cell is made lower than the second cell voltage, thus enabling reducing further deterioration of the first cell.

In an electricity storage system (1) according to a sixth aspect, which may be implemented in conjunction with any one of the first to fourth aspects, the electrical storage unit (11) includes a plurality of cells (11A-11C) connected together in series. The charging controller (23) charges the plurality of cells (11A-11C) to equalize respective charge voltages of the plurality of cells (11A-11C) with each other.

This aspect allows the plurality of cells (11A-11C) to be charged with balance struck well between the plurality of cells (11A-11C).

In an electricity storage system (1) according to a seventh aspect, which may be implemented in conjunction with any one of the first to sixth aspects, the discharge circuit (12, 12B) discharges, when the power supply (2) causes a failure, the electricity from the electrical storage unit (11) and supplies the electricity to the load (3).

This aspect allows the load to operate by supplying, when the power supply (2) causes a failure, electricity from the electrical storage unit (11) to the load (3).

A charging control method according to an eighth aspect is designed for use in an electricity storage system (1). The electricity storage system (1) includes a charge circuit (12, 12A) which charges an electrical storage unit (11) with electricity supplied from a power supply (2); and a discharge circuit (12, 12B) which outputs the electricity stored in the electrical storage unit (11) to a load (3). The charging control method includes detection processing, determination processing, and charging control processing. The detection processing includes detecting an electrical characteristic value that varies according to a degree of deterioration of the electrical storage unit (11). The determination processing includes determining, based on a result of detection in the detection processing, the degree of deterioration of the electrical storage unit (11). The charging control processing includes controlling a charging operation of the charge circuit (12, 12A). The charging control processing includes setting, when the degree of deterioration of the electrical storage unit (11) has been determined, in the determination processing, to be a first level, a charge voltage, with which the charge circuit (12, 12A) charges the electrical storage unit (11), at a first voltage (V1). The charging control processing includes setting, when the degree of deterioration of the electrical storage unit (11) has been determined, in the determination processing, to be a second level indicating more significant deterioration than the first level, the charge voltage at a second voltage (V2) higher than the first voltage (V1). The charging control processing includes setting, when the degree of deterioration of the electrical storage unit (11) has been determined, in the determination processing, to be a third level indicating more significant deterioration than the second level, the charge voltage at a third voltage (V3) higher than the second voltage (V2).

This aspect enables, by setting, when the degree of deterioration is the first level, the charge voltage at a lower voltage value than when the degree of deterioration is the second or third level, reducing not only the degree of decrease in capacitance but also the degree of increase in internal resistance, thus achieving the advantage of reducing the deterioration of the electrical storage unit (11).

In a charging control method according to a ninth aspect, which may be implemented in conjunction with the eighth aspect, a second increment representing a difference of the third voltage (V3) from the second voltage (V2) is less than a first increment representing a difference of the second voltage (V2) from the first voltage (V1).

This aspect allows the difference of the first voltage (V1) from the second voltage (V2) to be set at a lower voltage value than the difference of the second voltage (V2) from the third voltage (V3), thereby reducing not only the degree of decrease in the capacitance of the electrical storage unit (11) but also the degree of increase in the internal resistance thereof.

A program according to a tenth aspect is designed to cause a computer system to perform the charging control method according to the eighth or ninth aspect.

This aspect enables, by setting, when the degree of deterioration is the first level, the charge voltage at a lower voltage value than when the degree of deterioration is the second or third level, reducing not only the degree of decrease in capacitance but also the degree of increase in internal resistance, thus achieving the advantage of reducing the deterioration of the electrical storage unit (11).

Note that these are not the only aspects of the present disclosure but various configurations (including variations) of the electricity storage system (1) according to the exemplary embodiment described above may also be implemented as, for example, a charging control method for the electricity storage system (1), a (computer) program, or a non-transitory storage medium on which the program is stored.

Note that the constituent elements according to the second to seventh aspects are not essential constituent elements for the electricity storage system (1) but may be omitted as appropriate. The feature of the ninth aspect is not an essential feature of the charging control method for the electricity storage system (1) but may be omitted as appropriate.

### REFERENCE SIGNS LIST

1 Electricity Storage System
2 Power Supply
3 Load
11 Electrical Storage Unit
11A-11C Cell
12 Charge/Discharge Circuit (Charge Circuit, Discharge Circuit)
12A Charge Circuit
12B Discharge Circuit
21 Detector
22 Determiner
23 Charging Controller
V1 First Voltage
V2 Second Voltage
V3 Third Voltage

1. An electricity storage system comprising:
a charge circuit configured to charge an electrical storage unit with electricity supplied from a power supply;
a discharge circuit configured to output the electricity stored in the electrical storage unit to a load;
a detector configured to detect an electrical characteristic value that varies according to a degree of deterioration of the electrical storage unit;
a determiner configured to determine, based on a result of detection by the detector, the degree of deterioration of the electrical storage unit; and
a charging controller configured to control a charging operation of the charge circuit,
the charging controller being configured to:
set, when the determiner determines the degree of deterioration of the electrical storage unit to be a first level, a charge voltage, with which the charge circuit charges the electrical storage unit, at a first voltage;
set, when the determiner determines the degree of deterioration of the electrical storage unit to be a second level indicating more significant deterioration than the first level, the charge voltage at a second voltage higher than the first voltage; and
set, when the determiner determines the degree of deterioration of the electrical storage unit to be a third level indicating more significant deterioration than the second level, the charge voltage at a third voltage higher than the second voltage.

2. The electricity storage system of claim 1, wherein
the electrical characteristic value detected by the detector includes a capacitance of the electrical storage unit and an internal resistance of the electrical storage unit.

3. The electricity storage system of claim 1, wherein
a second increment representing a difference of the third voltage from the second voltage is less than a first increment representing a difference of the second voltage from the first voltage.

4. The electricity storage system of claim 1, wherein
the electrical storage unit includes a plurality of cells connected together in series, and
the determiner is configured to determine, based on cell decision values indicating respective degrees of deterioration of the plurality of cells, the degree of deterioration of the electrical storage unit as a whole.

5. The electricity storage system of claim 4, wherein
the charging controller is configured to set, according to the respective cell decision values of the plurality of cells, a first cell voltage at a value lower than a second cell voltage, the first cell voltage being a charge voltage for a first cell belonging to the plurality of cells, the second cell voltage being a charge voltage for a second cell belonging to the plurality of cells, the second cell deteriorating more slowly than the first cell.

6. The electricity storage system of claim 1, wherein
the electrical storage unit includes a plurality of cells connected together in series, and
the charging controller is configured to charge the plurality of cells to equalize respective charge voltages of the plurality of cells with each other.

7. The electricity storage system of claim 1, wherein
the discharge circuit is configured to, when the power supply causes a failure, discharge the electricity from the electrical storage unit and supply the electricity to the load.

8. A charging control method designed for use in an electricity storage system, the electricity storage system comprising:
a charge circuit configured to charge an electrical storage unit with electricity supplied from a power supply; and
a discharge circuit configured to output the electricity stored in the electrical storage unit to a load,
the charging control method including:
detection processing including detecting an electrical characteristic value that varies according to a degree of deterioration of the electrical storage unit;
determination processing including determining, based on a result of detection in the detection processing, the degree of deterioration of the electrical storage unit; and
charging control processing including controlling a charging operation of the charge circuit,
the charging control processing including:
setting, when the degree of deterioration of the electrical storage unit has been determined, in the determination processing, to be a first level, a charge voltage, with which the charge circuit charges the electrical storage unit, at a first voltage;
setting, when the degree of deterioration of the electrical storage unit has been determined, in the determination processing, to be a second level indicating more significant deterioration than the first level, the charge voltage at a second voltage higher than the first voltage; and
setting, when the degree of deterioration of the electrical storage unit has been determined, in the determination processing, to be a third level indicating more significant deterioration than the second level, the charge voltage at a third voltage higher than the second voltage.

9. The charging control method of claim 8, wherein
a second increment representing a difference of the third voltage from the second voltage is less than a first increment representing a difference of the second voltage from the first voltage.

10. A program designed to cause a computer system to perform the charging control method of claim 8.

11. The electricity storage system of claim 2, wherein
a second increment representing a difference of the third voltage from the second voltage is less than a first increment representing a difference of the second voltage from the first voltage.

12. The electricity storage system of claim 2, wherein
the electrical storage unit includes a plurality of cells connected together in series, and
the determiner is configured to determine, based on cell decision values indicating respective degrees of deterioration of the plurality of cells, the degree of deterioration of the electrical storage unit as a whole.

13. The electricity storage system of claim 3, wherein
the electrical storage unit includes a plurality of cells connected together in series, and
the determiner is configured to determine, based on cell decision values indicating respective degrees of deterioration of the plurality of cells, the degree of deterioration of the electrical storage unit as a whole.

14. The electricity storage system of claim 2, wherein
the electrical storage unit includes a plurality of cells connected together in series, and
the charging controller is configured to charge the plurality of cells to equalize respective charge voltages of the plurality of cells with each other.

15. The electricity storage system of claim 3, wherein
the electrical storage unit includes a plurality of cells connected together in series, and
the charging controller is configured to charge the plurality of cells to equalize respective charge voltages of the plurality of cells with each other.

16. The electricity storage system of claim 4, wherein
the electrical storage unit includes a plurality of cells connected together in series, and
the charging controller is configured to charge the plurality of cells to equalize respective charge voltages of the plurality of cells with each other.

17. The electricity storage system of claim 2, wherein
the discharge circuit is configured to, when the power supply causes a failure, discharge the electricity from the electrical storage unit and supply the electricity to the load.

18. The electricity storage system of claim 3, wherein
the discharge circuit is configured to, when the power supply causes a failure, discharge the electricity from the electrical storage unit and supply the electricity to the load.

19. The electricity storage system of claim 1, wherein
the discharge circuit is configured to, when the power supply causes a failure, discharge the electricity from the electrical storage unit and supply the electricity to the load.

20. The electricity storage system of claim 1, wherein
the discharge circuit is configured to, when the power supply causes a failure, discharge the electricity from the electrical storage unit and supply the electricity to the load.
